(19) United States
(12) Patent Application Publication
(10) Pub. No.: US 2010/0300796 A1
(43) Pub. Date: Dec. 2, 2010

(54) VEHICLE WITH A VARIABLE DRIVER POSITION

(75) Inventors: John Ryan, Millfield New South Wales (AU); Damien Moore, Edgeworth New South Wales (AU); Mark Chapman, Aberglasslyn New South Wales (AU); Graham Vought, Marrangaroo New South Wales (AU)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PWGK HOLDINGS PTY LIMITED, Ashtonfield NSW (AU)

(21) Appl. No.: 12/598,602

(22) PCT Filed: May 5, 2008
(86) PCT No.: PCT/AU2008/000629

§ 371 Date: Apr. 7, 2010

(30) Foreign Application Priority Data
May 4, 2007 (AU) 2007902375

(51) Int. Cl. B60K 26/00

(52) U.S. Cl. 180/329

(57) ABSTRACT

There is disclosed a wheeled vehicle (10) adapted to be driven in a primary direction or an opposite secondary direction. The vehicle has a vehicle platform (32), and a group of vehicle components rotatably mounted on the platform which are rotatable as a group through 180 degrees relative to the platform. The group of components includes a driver's seat (38), steering wheel (40), foot pedals (42) and instrument console (44). Rotation of the group of components enables the driver's seat (and hence the driver) to face in the primary direction or secondary direction.

### FIELD OF THE INVENTION

This invention relates to a vehicle with a variable driver position.

### BACKGROUND TO THE INVENTION

In the underground mining industry, there is a high rate of injury to machine operators which may be attributed to a combination of the harsh environment and equipment which is not entirely suitable for this environment. Indeed, common contributors to operator injury include rough roadway conditions and the poor standard of seating for the operators of these machines. This results in undesirable body vibration, shock loads and fatigue. These problems are experienced in particular by drivers of underground mining vehicles, due largely to the poor ergonomics of the drivers' seating positions and the relative positions of the vehicles' controls.

This problem is exacerbated by the fact that in many underground mining scenarios, due to the extremely limited width of underground roadways, vehicles are required to travel forwards when proceeding in one direction along a roadway, and rearwards when proceeding in the opposite direction along the road, as there is insufficient space for such vehicles to turn around.

There are two known driver and control configurations that have been used to address this problem.

According to one of the known configurations, on such machines there are provided two driver's seats positioned opposite each other, one facing in one direction of travel of the vehicle and the other facing in the opposite direction of travel. At any time, the driver uses the seat which is appropriate for the vehicle's direction of travel at that time. However, this configuration has various disadvantages. One disadvantage is that only a single steering wheel and set of controls is provided (other than the foot pedals) and these are positioned at right angles to the direction in which the two seats face. This provides for poor ergonomics and significant lack of comfort for the driver. In addition, the cramped space makes it awkward and inconvenient for the driver to move from one seat to the other when the vehicle's direction of travel is to be changed. Furthermore, it will be appreciated that when the driver is in one of the seats facing in one direction, the steering wheel is on his right hand side whereas when he is in the other seat, it is on his left hand side. Thus, the driver is required to use different hands for operating the steering wheel and controls depending on the direction of travel, and it is difficult and counter-intuitive for drivers to adapt to the changing relative position of these controls The need to replicate the foots pedals also gives rise to an undesirable expense.

According to another of the known configurations of such vehicles, the seat, steering wheel and controls are positioned at right angles to the vehicle's forward and reverse directions of travel and the driver therefore also faces at right angles thereto. Disadvantages of this configuration include that the operator must turn his head through substantially 90 degrees in order to look in the direction of travel. This seating position, together with the harsh and bumpy terrain can cause discomfort and injury to the driver.

### SUMMARY OF THE INVENTION

According to the invention there is provided a wheeled vehicle having a steering control and adapted to be driven in a vehicle primary direction and a vehicle secondary direction opposite to the primary direction, the vehicle including:
a vehicle platform configured to be supported, by way of the vehicle wheels, on a road surface; and
a group of vehicle components including a driver's seat and a predetermined set of vehicle instruments, the group of components being rotatably mounted on the vehicle platform so as to be rotatable as a group relative to the platform through 180 degrees between a first position in which the driver's seat faces in the vehicle primary direction and a second position in which the driver's seat faces in the vehicle secondary direction.

In a preferred embodiment, the predetermined set of vehicle instruments includes the steering control for the vehicle. The steering control preferably includes a steering wheel.

In a preferred embodiment, the predetermined set of vehicle instruments includes foot pedals, which preferably include an accelerator pedal and a brake pedal.

In a preferred embodiment, the predetermined set of vehicle instruments includes a control console.

In a preferred embodiment, the vehicle includes a base, said group of vehicle components being mounted on the base, and the base being rotatably mounted on the vehicle platform. Preferably, the vehicle includes a slew bearing, the base being rotatably mounted on the vehicle platform by means of the slew bearing.

In one preferred embodiment, the base is manually rotatable relative to the vehicle platform.

In another preferred embodiment, the vehicle includes hydraulic rotation means adapted to rotate the base relative to the vehicle platform. Then, preferably, the hydraulic rotation means includes an hydraulic motor and an actuator for rotating the base. Preferably, also, the hydraulic rotation means includes an hydraulic motor and a pinion gear configured for rotating the base. The pinion gear is preferably configured to engage a complementary gear on the slew bearing for rotating the base.

In yet another preferred embodiment, the vehicle includes electric rotation means adapted to rotate the base relative to the vehicle platform. Preferably, the electric rotation means includes an electric motor and a pinion gear configured for rotating the base. Then, preferably, the pinion gear is configured to engage a complementary gear on the slew bearing for rotating the base.

In a preferred embodiment, the vehicle is configured with a selectable rotation mode wherein, when the rotation mode is selected, the steering control is operable to effect, and determine the direction of, rotation of said group of vehicle components relative to the platform.

In a preferred embodiment, the vehicle includes a pair of driver foot safety actuators, the vehicle being configured to prevent rotation of said group of vehicle components unless said safety actuators are actuated together. Preferably, the actuation of said safety actuators at the same time selects said rotation mode.

Also In a preferred embodiment, the vehicle includes a parking brake which is adapted to be automatically activated to prevent movement of the vehicle in either of said primary and secondary directions while said group of vehicle components is being rotated relative to said vehicle platform.

In a preferred embodiment, the vehicle includes vehicle drive means for driving the vehicle in said primary and secondary directions, and a sensor control for sensing if said group of vehicle components is neither in said first position nor said second position, and in that case for deactivating said vehicle drive means to prevent the vehicle from being driven in either of said primary and secondary directions. Preferably, said sensor control is configured to sense if said group of vehicle components is in either said first position or said second position, and thereupon to enable activation of said vehicle drive means.

In a preferred embodiment, the vehicle includes controls for selecting a forward direction mode for causing the vehicle to be driven in a forward direction, or a reverse direction mode for causing the vehicle to be driven in a reverse direction which is opposite to the forward direction, wherein said sensor control is adapted to set the forward direction to correspond to the primary direction when the driver's seat is facing in the primary direction and to the secondary direction when the driver's seat is facing in the secondary direction.

In a preferred embodiment, the vehicle includes a seat locking means adapted to automatically lock the driver's seat in place when said group of vehicle components is rotated into the first position or into the second position.

### BRIEF DESCRIPTION OF THE DRAWINGS

Preferred embodiments of the invention will now be described, by way of example only, with reference to the accompanying drawings in which:

FIG. 1 is a schematic perspective representation of an underground mining vehicle according to an embodiment of the invention;

FIG. 2 is a schematic perspective view from the front of a driver pod of the vehicle of FIG. 1, including a driver's seat and a group of vehicle controls and instruments;

FIG. 3 is a schematic side view of the pod of FIG. 2;

FIG. 4 is a schematic front view of a control console of the vehicle;

FIG. 5 is a schematic side view of a driver pod according to an embodiment of the invention;

FIG. 6 is a schematic plan view of the pod of FIG. 5;

FIG. 7 is a schematic perspective view, from the rear, of the pod of FIG. 5; and

FIG. 8 is a schematic front view of the pod of FIG. 5.

### DETAILED DESCRIPTION

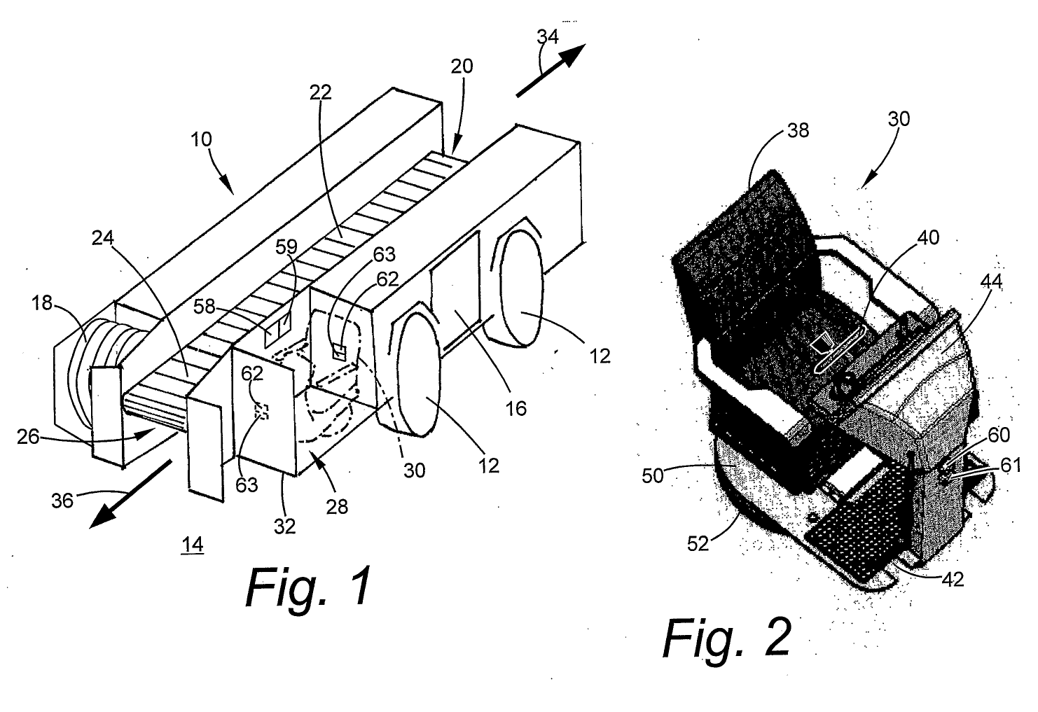

Referring to FIG. 1, there is shown a wheeled underground mining vehicle 10, which, in the present example, is in the form of a coal shuttle. The vehicle 10 has four wheels 12 by which the vehicle is supported on a roadway surface 14. In the present example, the roadway is a narrow roadway leading to a coal-mining face (not shown).

The vehicle 10 has an electrical traction control drive 16 for driving the vehicle via the wheels 12. The traction control drive 16 is connected, by a suitable cable, to an electrical power source for providing power to the traction control drive (the cable and power source not being shown). A reel 18 is provided on the vehicle 10, onto which the cable can be wound as the vehicle 10 approaches the power source (in which event a shorter length of cable between the power source and vehicle is required) and from which the cable can be unwound as the vehicle moves away from the power source (in which event a greater length of cable is required).

The vehicle 10 defines a central channel 20 in which there is a conveyor system 22. At one end of the channel 20 there is a cantilevered boom 24, the free end 26 of which can be raised and lowered.

Adjacent to the channel 20 is a driver's cabin area 28 in which is accommodated a driver's pod 30 (shown in phantom lines in FIG. 1) which includes various components of the vehicle 10 and which is described further, below.

The chassis of the vehicle 10, including the floor of the driver's cabin area 28, is referred to below as the vehicle platform, and is generally designated 32.

The vehicle 10 is used to convey coal. In particular, it is driven to the coal face (not shown) where mined coal is deposited on the conveyor system 22. Once sufficient coal has been loaded, the vehicle 10 is driven in an opposite direction, away from the coal face, to another, remote location at which the coal is transferred, by means of the conveyor system 22, onto another type of conveyance (not shown) which transports the coal away from the mining area.

The boom 24 can be used to effectively match the height of the conveyor system 22 to that of the other conveyance to facilitate loading of the coal onto it.

As the roadway surface 14 is narrow, it is not practicable or possible to turn the vehicle 10 around after it has reached the coal face so that it can be driven away, or, once it has reached its distant location, so that it can be driven back to the coal face. As a result, the vehicle 10 essentially is required to be driven in two opposite directions. In the present example, the direction indicated by the arrow 34 is referred to as a vehicle primary direction of travel, and the direction indicated by the arrow 36 is referred to as a vehicle secondary direction of travel.

Both the primary and secondary directions of travel 34, 36 are equally important with regard to the usage of the vehicle 10. The driver's pod 30 is provided to facilitate driving of the vehicle 10 in both of these directions.

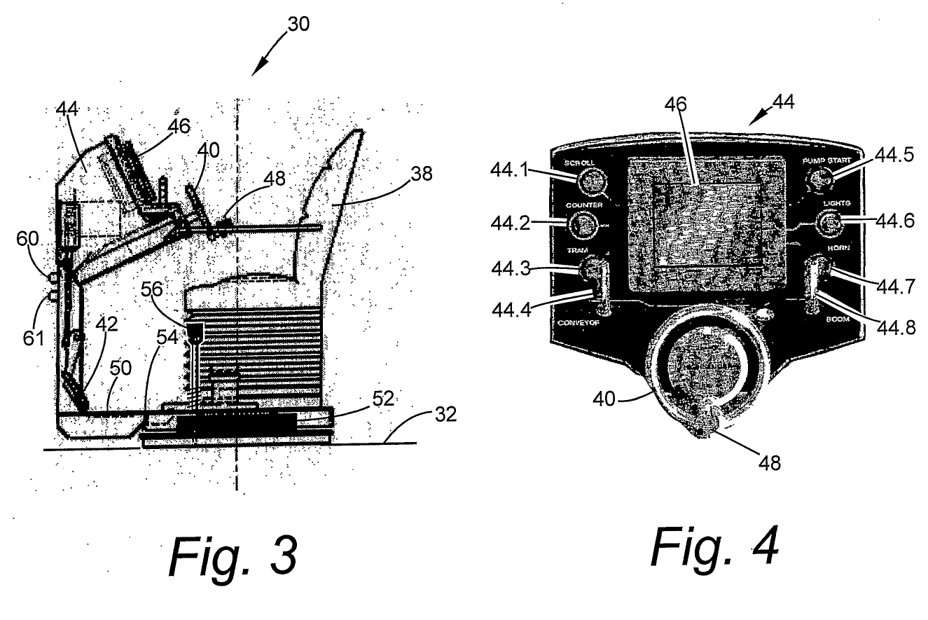

As best seen in FIGS. 2 and 3, the pod 30 includes a group of vehicle components including a driver's seat 38 and a set of vehicle controls and instruments. These include an hydraulic steering control for the vehicle, in the form of a steering wheel 40, foot pedals 42 including an accelerator and brake pedal, and an instrument console 44.

As seen in FIG. 4, the instrument console 44 includes a “scroll” button 44.1. This is provided for selecting pages of the display on a screen 46 which is located in the centre of the console 44. This screen 46 serves as a machine monitoring and diagnostics display. Also included on the instrument console 44 is a “counter” button 44.2 for counting loads of coal conveyed by the vehicle 10 during a particular period or shift, a “tram” button 44.3 for reversing the direction of travel (“tram”) of the vehicle, a “conveyor” lever 44.4 for controlling the operation of the conveyor system 22, a “pump start” button 44.5 for starting an electric pump motor which enables the vehicle to start operation, a “lights” button 44.6 for switching on and off the driving lights (not shown) of the vehicle 10, a “horn” button 44.7 for actuating the vehicle's horn (not shown) and a “boom” lever 44.8 for controlling the operation of the boom 24 of the conveyor system.

The steering wheel 40 includes a rotatable knob 48 to enable one-handed operation of the steering wheel.

The pod 30 is rotatable so that the driver's seat 38, together with the above-mentioned vehicle components can be rotated though 180 degrees relative to the vehicle platform 32. In particular, the pod 30, including the driver's seat 38 and hence the driver, can be rotated between a first position in which the seat and driver face in the primary direction of travel 34, and a second position in which the seat and driver face in the secondary direction of travel 36. As the driver's seat 38 and above-mentioned components all rotate together on rotation of the pod 30, the positional relationship between the driver and these parts of the vehicle 10 remain constant regardless of the direction in which the driver is facing.

The pod 30 has a base 50 which is supported on the vehicle platform 32 by means of a slew bearing 52 to enable the rotatability of the pod relative to the vehicle platform.

In one preferred embodiment of the invention, the base 50 and hence the pod 30 is manually rotatable relative to the vehicle platform 32 by using other parts of the vehicle 10 on which to push or pull so that the reaction forces of doing so cause the rotation.

In another embodiment, the vehicle 10 includes hydraulic circuitry (not shown) configured to rotate the base 50 and pod 30 when the hydraulics are suitably actuated. In this case, the hydraulic circuitry includes an hydraulic motor and an actuator (not shown) for rotating the base 50. In one preferred form of this embodiment, the vehicle 10 includes a pinion gear (not shown) connected to the actuator which is engaged with a complementary gear on the slew bearing 52 to convert movement of the actuator into rotational movement of the base 50.

According to yet another preferred embodiment, the vehicle 10 includes electric rotation means (not shown) adapted to rotate the base 50 relative to the vehicle platform 32. In this case, the electric rotation means includes an electric motor and a pinion gear (not shown) coupled to the motor, with a complementary gear (not shown) on the slew bearing 52, to enable the electric motor to rotate the base 50.

The pod 30 includes a pair of adjacent driver safety foot actuators 54 located on the base 50. The pod 30 is adapted so that it cannot be rotated relative to the vehicle platform 32 unless both foot actuators 54 are depressed at the same time. This ensures that the driver's feet are within the bounds of the pod 30 and hence within the bounds of the cabin area 28 during rotation, which in turn prevents the driver's feet from protruding from the pod and becoming injured due to the pod's rotation. As described in more detail below, in preferred embodiments, the foot actuators 54 also activate parking brakes of the vehicle 10 to prevent movement of the vehicle during rotation of the pod 30, and, when depressed at the same time, enable rotation of the pod by means of rotation of the steering wheel 40.

In one preferred form of the embodiment where hydraulic rotation means are provided, the foot actuators 54 form controls for the hydraulic circuitry and are configured to prevent the hydraulic system from causing the pod 30 to rotate when the foot actuators are not depressed, but which enable rotation when depressed.

A similar arrangement can be used as a preferred form of the embodiment where electric rotation means are provided.

Also in a preferred embodiment, the foot actuators 54 serve as an actuator for an hydraulic logic valve (not shown). Thus, when the foot actuators 54 are depressed at the same time, this controls the hydraulic circuitry to configure the steering wheel 40 so that it serves as a rotation actuator. In this event, rotation of the steering wheel 40 causes rotation of the base 50 and hence of the pod 30, with the direction of rotation (clockwise or anticlockwise) being dependent on—and preferably corresponding to—the direction of rotation of the steering wheel.

Similarly, where the above arrangement is employed in an embodiment of the vehicle 10 in which electric rotation means are provided as described above, then depressing the foot actuators 54 serves to connect the steering wheel 40 to electronic circuitry which enables the steering wheel to control the rotation of the base 50 and pod 30, and to disconnect it from the steering mechanism of the vehicle.

The vehicle 10 is also provided with a parking brake (not shown). The brake is adapted to be automatically activated when the foot actuators 54 are depressed at the same time, to lock the wheels 12 of the vehicle 10. Thus, the brake serves to prevent movement of the vehicle 10 in the primary and secondary directions 34, 36 while the pod 30 is being rotated relative to the vehicle platform 32.

There is also provided a rotation lock 56. The rotation lock 56 includes a rod which is positioned towards the front left side of the driver's seat 38, and which is configured to locate the base 50 of the pod 30 to the vehicle platform 32. It thus serves to locate the pod 30 in the correct position for either the primary or secondary directions of travel 34, 36, and to lock it against rotation relative to the vehicle platform 32. The rotation lock 56 is spring loaded so as to be kept positively in its locating position, but can be lifted against the spring loading to release the base 50 from the vehicle platform 32 when rotation of the pod 30 is required.

A proximity sensor system is provided, and includes sensor controls 58 and 59 located within the driver's cabin area 28, a pair of actuators 60 and 61 mounted on the front side of the console 44 as indicated in FIG. 2, and two pairs of sensors 62 and 63 mounted on the walls of, and within, the driver's cabin area 28. Despite the position of the sensor controls 58 and 59 as shown in FIG. 1, it is to be appreciated that these sensor controls can be located in any other suitable position on the vehicle 10.

The walls on which the sensors 62, 63 are located are opposite each other as shown. Because of the relative positions of the actuators 60, 61 and sensors 62, 63, the actuators are positioned to be in close proximity to one or the other pair of the sensors depending on whether the pod 30 is in its first position or its second position. When it is in such a position and the actuators 60, 61 are in proximity to one of the pair of sensors 62, 63, the actuators activate those sensors. From the state of activation or non-activation of the sensors 62, 63, the sensor controls 58 and 59 determine if the pod 30 is in its first or second position or neither of these positions.

The sensor control 58 is configured such that, when the pod 30 is in neither of its first and second positions (i.e. when it is rotating) the sensor control as activated by the sensors 60 causes the traction control drive 16 to be deactivated to prevent the vehicle 10 from being driven in either of the primary or secondary directions 34 and 36.

Similarly, the sensor control 58 is configured to sense if the pod 30 is in either of the first or second positions (i.e. when the actuator 60 is in proximity to one of the sensors 62). In this case, the sensor control 58 enables activation of the traction control drive 16.

As mentioned above, the “tram” button 44.3 on the console 46 is for setting the vehicle 10 in a forward mode of travel or a reverse mode of travel, for enabling the vehicle to be driven in a forward or reverse direction. This means a forward direction or reverse direction relative to the direction in which the driver is facing. The sensor control 58 as activated by the sensor 60 is configured to set this forward direction to correspond to the primary direction 34 when the driver's seat 38 is facing in the primary direction, and to correspond to the secondary direction 36 when the driver's seat is facing in the secondary direction, and to set the reverse direction in each case to the opposite respective direction.

Accordingly, whether the pod 30 is in its first or second position, when the driver wishes to proceed in the forward direction (i.e. in the direction in which he is facing) he depresses the accelerator pedal 42. If he wishes to proceed in the reverse direction (i.e. in the direction opposite that in which he is facing) he presses the “tram” button 44.3 and then depresses the accelerator pedal 42.

It will be appreciated that the accelerator pedal 42 can be positioned to the left or right of the and brake pedal, depending on the usage requirements or preferences for the particular vehicle 10.

The relevant sensor 63, when actuated by the actuator 61 (i.e. when the pod 30 enters its first or second position) activates the sensor control 59 so that it causes the parking brake (as mentioned above which was applied by depressing the foot actuators 54) to be released. In addition, it serves to switch the function of the steering wheel 40 back from controlling rotation of the pod 30 to controlling the steering of the vehicle 10.

The pod 30 is also configured such that, as it is rotated from the first position to the second position or vice versa, the sensor control 59 causes the steering control hydraulics to switch the steering direction to suit the relevant direction of travel—for example so that a clockwise rotation of the steering wheel 40 will cause rightward steering of the vehicle 10 in whichever of the primary and secondary directions 34, 36 the vehicle is travelling.

The above description discloses two sensors 62 and 63 in each pair of sensors, two actuators 60 and 61, and two sensor controls 58 and 59, with these sensors, actuators, and sensor controls performing the functions as described. However, it is to be appreciated that, in other embodiments, the allocation of these functions to those components may be differently arranged. As a further alternative, these functions might be performed by way of only a single sensor in place of each pair, a single actuator, and a single sensor control.

In use, after the vehicle 10 has reached its destination in the primary direction of travel 34 (for example the coal face) and it is desired to drive the vehicle in the opposite, secondary direction 36, the driver can cause the pod 30 to rotate through 180 degrees relative to the vehicle platform 32 so that the driver's seat 38 faces in the secondary direction. The manner of causing the pod 30 to rotate depends on the features of the particular embodiment, for example whether manual rotation is required, or rotation by means of an hydraulic system, or rotation by means of an electrical system, as described above.

To ensure that the driver's seat 38 itself does not constitute an obstacle to rotation, in one preferred embodiment the driver's seat is slidably adjustable in a forward and reverse direction relative to the direction in which the seat faces, and it is required for the driver's seat to be slid to its forward-most position before rotation can occur.

Preferred embodiments of the invention may include the following features relating to the driver's seat 38:
a protective coating on the driver's seat to ensure minimal wear and ease of cleaning;
additional lumber support to enhance the driver's comfort and to reduce the risks of Whole Body Vibration;
shock absorbers in the base of the driver's seat to minimise the impact of vibrations and rough roadways on the driver;
adjustability of the driver's seat to enhance driver comfort both in relation to leg room and in relation to tilting of the seat backrest; this allows the driver's seat to more comfortably accommodate drivers of many different sizes;
a seat belt to ensure that the driver is constrained within the confines of the driver's cabin area 28.

Similarly, preferred embodiments of the invention may include the following features relating to the driver's cabin area 28:
an interlock door (not shown) for the cabin area which is configured such that, when it is not locked, it prevents inadvertent movement of vehicle;
an automatic anti-pinch safety device (not shown) on the door to prevent pinch injuries to the driver;
a video monitor (not shown) to view areas of, and around, the vehicle 10 that would otherwise be “blind spots” for the driver, to provide improved visibility.

Advantages of the invention include that the relative position of the components mounted on the pod 30 remains substantially constant whether the pod is orientated for the driver's seat 38 to be facing in the primary direction of travel 34 or in the secondary direction 36. Thus, the driver is essentially not required to re-adapt to changing positions of such components each time the direction of travel of the vehicle 10 changes between the primary and secondary directions 34, 36. In addition, the driver, while using those controls and components, can be facing in the relevant direction of travel. Thus the rotatable pod 30, in preferred embodiments, can provide increased safety and improved ergonomics relative to prior art systems. In addition, the need to duplicate those controls on the pod 30 is avoided.

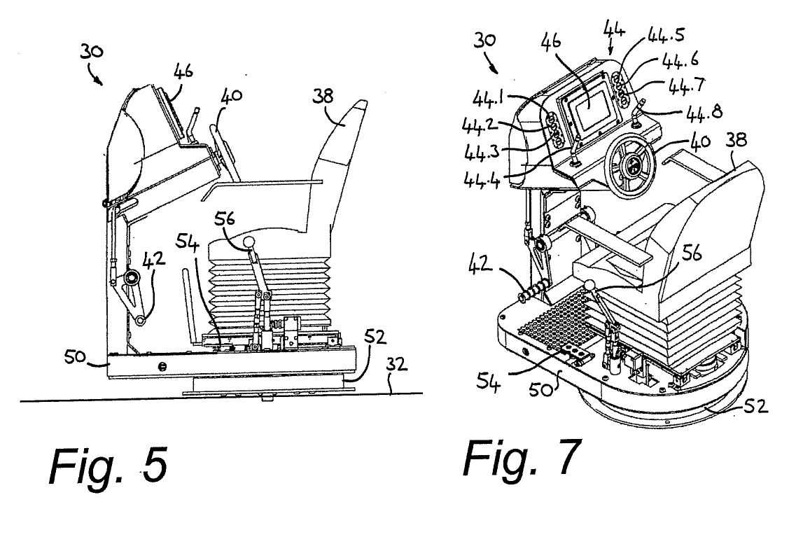

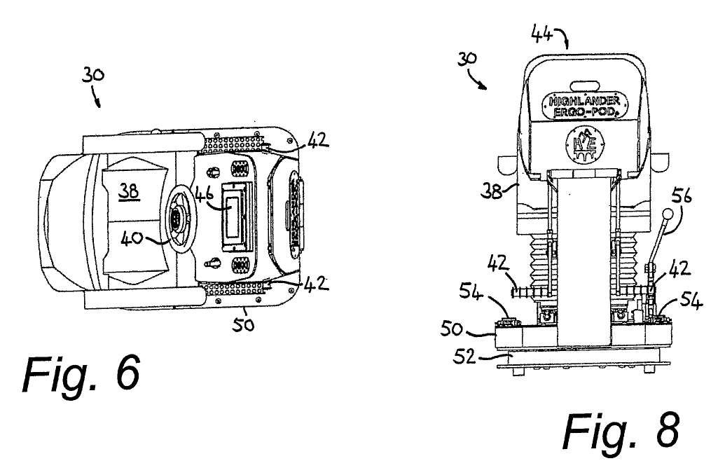

Referring to FIGS. 5 to 8, there is shown another embodiment of the invention. Reference numerals as used in these figures designate features corresponding to features in the previous drawings designated by the same reference numerals. The same description as provided in relation to the previous drawings applies to FIGS. 5 to 8.

While the invention is described above in relation to specific embodiments, it will be appreciated by those skilled in the art that the invention is not limited to those embodiments but may be embodied in many other forms.

1. A wheeled vehicle having a steering control and adapted to be driven in a vehicle primary direction and a vehicle secondary direction opposite to the primary direction, the vehicle including:
a vehicle platform configured to be supported, by way of the vehicle wheels, on a road surface; and
a group of vehicle components including:
a driver's seat;
a driver foot safety actuator; and
a predetermined set of vehicle instruments, the group of components being rotatably mounted on the vehicle platform so as to be rotatable as a group relative to the platform through 180 degrees between a first position, in which the driver's seat faces in the vehicle primary direction, and a second position, in which the driver's seat faces in the vehicle secondary direction, the vehicle being configured to prevent rotation of said group of vehicle components unless the driver foot safety actuator is actuated, the vehicle further configured to lock the wheels upon actuation of the foot safety actuator and to configure the steering control to effect rotation of the group of vehicle components relative to the platform.

2. A wheeled vehicle according to claim 1, wherein the driver foot safety actuator includes a pair of safety actuators positioned proximate the seat, with rotation of the components only allowed when both of the actuators are actuated.

3. (canceled)

4. A wheeled vehicle according to claim 1, wherein the predetermined set of vehicle instruments includes foot pedals.

5-6. (canceled)

7. A wheeled vehicle according to claim 1, including a base with said group of vehicle components being mounted on the base, and the base being rotatably mounted on the vehicle platform.

8. A wheeled vehicle according to claim 7, including a slew bearing, the base being rotatably mounted on the vehicle platform by means of the slew bearing.

9. A wheeled vehicle according to claim 7, wherein the base is manually rotatable relative to the vehicle platform.

10. A wheeled vehicle according to claim 7, including a hydraulic motor and an actuator adapted to rotate the base relative to the vehicle platform.

11. (canceled)

12. A wheeled vehicle according to claim 7, including a hydraulic motor and a pinion gear configured for rotating the base relative to the vehicle platform.

13. A wheeled vehicle according to claim 7, including:
a slew bearing;
a hydraulic motor and a pinion gear; and
a complementary gear on the slew bearing, wherein the pinion gear is configured to engage the complementary gear for rotating the base relative to the vehicle platform.

14. A wheeled vehicle according to claim 7, including an electric motor and a pinion gear adapted to rotate the base relative to the vehicle platform.

15. (canceled)

16. A wheeled vehicle according to claim 7, including:
a slew bearing;
an electric motor and a pinion gear; and
a complementary gear on the slew bearing, wherein the pinion gear is configured to engage the complementary gear for rotating the base relative to the vehicle platform.

17. A wheeled vehicle according to claim 1, wherein the steering control is operable to determine the direction of rotation of said group of vehicle components relative to the platform.

18. A wheeled vehicle according to claim 1, including a parking brake which is adapted to be automatically activated to prevent movement of the vehicle in either of said primary and secondary directions while said group of vehicle components is being rotated relative to said vehicle platform.

19. A wheeled vehicle according to claim 1, including vehicle drive means for driving the vehicle in said primary and secondary directions, and a sensor control for sensing if said group of vehicle components is neither in said first position or said second position, and in that case for deactivating said vehicle drive means to prevent the vehicle from being driven in either of said primary and secondary directions.

20. A wheeled vehicle according to claim 19, wherein said sensor control is configured to sense if said group of vehicle components is in either said first position or said second position, and thereupon to enable activation of said vehicle drive means.

21. A wheeled vehicle according to claim 19, including controls for selecting a forward direction mode for causing the vehicle to be driven in a forward direction, or a reverse direction mode for causing the vehicle to be driven in a reverse direction which is opposite to the forward direction, wherein said sensor control is adapted to set the forward direction to correspond to the primary direction when the driver's seat is facing in the primary direction and to the secondary direction when the driver's seat is facing in the secondary direction.

22. A wheeled vehicle according to claim 1, including a seat locking means adapted to automatically lock the driver's seat in place when said group of vehicle components is rotated into the first position or into the second position.

23. A wheeled vehicle according to claim 1, wherein the group of vehicle components is included in a pod rotatably mounted on the vehicle platform, the foot safety actuator positioned so that actuation thereof requires a driver's feet to remain within the pod to prevent injury to the driver resulting from protrusion of the feet during rotation of the pod.

24. A wheeled vehicle according to claim 22, wherein the foot safety actuator includes the seat locking means.

25. A wheeled vehicle having a steering control and adapted to be driven in a vehicle primary direction and a vehicle secondary direction opposite to the primary direction, the vehicle including:
a vehicle platform configured to be supported, by way of the vehicle wheels, on a road surface; and
a group of vehicle components including a driver's seat and a predetermined set of vehicle instruments, the group of components being rotatably mounted on the vehicle platform so as to be rotatable as a group relative to the platform through 180 degrees between a first position in which the driver's seat faces in the vehicle primary direction and a second position in which the driver's seat faces in the vehicle secondary direction.
